(19) United States
(12) Patent Application Publication
(10) Pub. No.: US 2002/0121821 A1
(43) Pub. Date: Sep. 5, 2002

(54) Method and apparatus for reducing bearing current in a motor and/or generator

(76) Inventor: Allen Michael Ritter, Salem, VA (US)

Correspondence Address: Thomas M. Blasey, Esq., Hunton & Williams, Suite 1200, 1900 K Street, NW, Washington, DC, 20006-1109, US

(21) Appl. No.: 09/798,093

(22) Filed: Mar. 2, 2001

(51) Int. Cl. H02K 11/00

(52) U.S. Cl. 310/71; 310/67 R

(57) ABSTRACT

The present invention enables removal of unwanted shaft currents from motors and/or generators by effectively placing a seal or a bushing in contact with the motor housing and the motor shaft. Many existing motor units can be effectively retrofitted to include these efficient current discharge mechanisms.

### BACKGROUND OF THE INVENTION

The present invention relates generally to rotating electrical machinery such as motors and generators, and more particularly to a highly reliable method and apparatus for diverting destructive current from motor bearings through the implementation of a novel shorting mechanism.

The design and operation of rotating electrical machines have recognized problems created by unwanted shaft voltages and bearing currents created as a consequence of routine operation of the machines. The shaft voltages and currents can be induced on a motor shaft by several phenomena. For example, induced currents can be caused by non-uniform air gap magnetic flux transitions within the motor. In other words, the difference between individual poles in a motor (although ideally identical) cause an induced current to be formed in the motor shaft. Additionally, the use of variable speed drives and the associated controllers (e.g., pulse width modulation type) can also cause abrupt current transients and associated magnetic flux transitions that cause unwanted induced current in the motor shaft.

To enable efficient operation, these induced currents and voltages should be discharged without endangering the operation of the motor. Conventional methods of discharging the induced current include providing a discharge path where the current is not discharged through the motor bearing assembly. However, stable operation of motor bearings located in the bearing assembly depends on proper operation of the bearings. If the induced current is discharged through the bearings, used as a medium between the moving and non-moving parts of the motor, the bearings quickly break down, thereby reducing the efficiency of the motor. Thus efforts within the industry turned to the diversion of the potentially destructive induced current from the bearings.

Heretofore, devices that have been employed to divert the current include a brush holder connected to the frame of the motor with a brush riding on the shaft of the motor. However, because the motor shaft is not situated within a controlled environment, the surface conditions of the motor shaft is replete with variations such as pits and manufacturing tolerance variations. The variations result in the formation of a high impedance along the interface between the motor shaft and the brush that prevents optimal current discharge.

Other attempts to properly discharge the induced current include insulating the bearings in the motor. However, this creates an additional expense in the manufacture of the motor. Moreover, if the motor shaft is connected to another load with a bearing, the shaft voltage will be transferred to that load bearing. As a result, the problem is merely transferred and not solved.

Also, as illustrated in U.S. Pat. No. 5, 914,547 to Barahia, for example, auxiliary bearing assemblies have been employed to reduce unwanted currents in motor bearings. However, the use of such an auxiliary bearing assembly is expensive and can quickly degrade thereby reducing motor efficiency. When the auxiliary bearings (that include conductive grease) degrade, current is either isolated on the shaft, producing unwanted motor deficiencies or the current discharges through the ball bearing assembly degrading the ball bearings and also reducing motor efficiency. Thus, for twice the expense and increased installation time the efficiency of current discharge is not efficiently re routed. Furthermore, the use of such an assembly commonly requires the motor shaft to be designed to accept a male fitting, thereby reducing the ability for easy retrofitting.

Thus, there is still a need for an inexpensive, durable and convenient manner of enabling easy retrofitting of a shaft current reduction mechanism that eliminates the induced current and shaft voltages in electric motors.

### BRIEF SUMMARY OF THE INVENTION

In accordance with exemplary embodiments of the present invention, unwanted motor currents can be efficiently discharged inexpensively. Additionally, by using the teachings of the present invention, many existing motor units can be effectively retrofitted to include these efficient current discharge mechanisms.

An exemplary embodiment of the present invention is an apparatus used in combination with a motor for discharging current. The motor includes a housing and a rotatable motor shaft. The apparatus comprises a bushing in electrical contact with both and an the housing and the shaft, the bushing further comprises a first part made of conductive material in electrical contact with the shaft, a second part made of conductive material in electrical contact with the housing, and a conductive grease at an interface between the first part and the second part. The apparatus also includes a bracket connected to the housing.

Another exemplary embodiment of the present invention is a method for installing a current discharge device on a motor. The motor includes a housing at an electrical ground potential and a rotatable motor shaft comprising induced currents. The method comprises the steps of removing a bracket located on the motor, placing a completely electrically conductive bushing into the motor so that a first part of the bushing is in electrical contact with the motor shaft and a second part of the bushing is in electrical contact with a motor housing, and rotating the rotatable motor shaft to remove any induced currents from the motor shaft.

Yet another exemplary embodiment of the present invention is an apparatus used in combination with a motor for discharging current wherein the motor includes a housing at an electrical ground potential and a rotatable motor shaft comprising induced currents. The apparatus comprises a seal in electrical contact with both and the housing and the shaft and a bracket connected to the housing. The seal further comprises a first part made of conductive material in electrical contact with the shaft and a second part made of conductive material in electrical contact with the housing, wherein said first part creates a seal completely around the circumference of the shaft.

Yet another exemplary embodiment of the present invention is a method for installing a current discharge device on a motor. The motor includes a housing at an electrical ground potential and a rotatable motor shaft comprising induced currents. The method comprises the steps of removing a bracket located on the motor, placing a completely electrically conductive seal into the motor so that a first part of the seal is in electrical contact with the motor shaft and a second part of the seal is in electrical contact with a motor housing, and rotating the rotatable motor shaft to remove any induced currents from the motor shaft.

### BRIEF DESCRIPTION OF THE DRAWINGS

The present invention can be understood more completely by reading the following Detailed Description of exemplary embodiments, in conjunction with the accompanying drawings, in which:

FIG. 1 is a partial cut away sectional side view of a motor comprising a current diverting bushing located on an a motor shaft in accordance with a first exemplary embodiment of the present invention;

FIG. 2 is an axial view of the bushing while installed on a motor shaft in accordance with an exemplary embodiment of the present invention;

FIG. 3 is a partial cut away sectional side view of a motor comprising a current diverting seal located on an a motor shaft in accordance with a second exemplary embodiment of the present invention; and

FIG. 4 is an axial view of a seal installed on a motor shaft in accordance with an exemplary embodiment of the present invention.

### DETAILED DESCRIPTION OF THE INVENTION

Exemplary embodiments of the present invention will now be described with reference to the accompanying drawings, in which various exemplary embodiments of the invention are shown. However, this invention may be embodied in many different forms and should not be construed as limited to the specific embodiments shown.

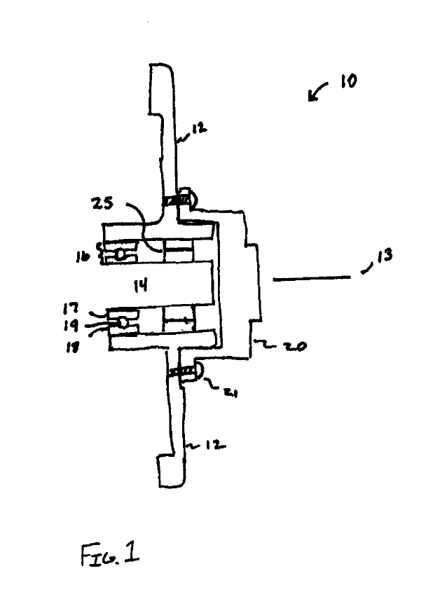

An exemplary embodiment of the present invention is illustrated in the partial side cut away side view of motor assembly 10 in FIG. 1. The motor assembly 10 includes a housing 12 that surrounds a conventional electric motor having a rotating motor shaft 14, journalled for rotation about an axis of rotation 13. The housing which encases the rotor, stator, etc. (not illustrated), in accordance with an exemplary embodiment of the present invention is maintained at a ground electrical potential. The motor shaft 14 is supported by a standard bearing assembly 16. While exemplary embodiments of the present invention illustrate the bearing assembly 16 located near the end of the motor shaft 14, it should be understood that the bearing assembly 16 could be located at any location in the motor assembly as individual design requirements specify. For example, the bearing assembly 16, as illustrated in FIG. 1, is located near the end of the motor shaft 14 so that it can be easily reached in case repair or replacement is required.

The bearing assembly 16 further includes an inner race 17 and outer race 18. The inner race 17 is in direct engagement with the motor shaft 14 while the outer race 18 is in direct engagement with the housing 12. A ball bearing 19 located between the outer race 18 and inner race 17 enables nearly frictionless contact between races as the motor shaft rotates. Also, in accordance with an exemplary embodiment of the invention, a bracket 20 is attached via screws 21 to the end of the housing to enable easy access to the internal contents of the motor assembly 10, such as the bearing assembly 16 for repair or replacement of parts. While exemplary embodiments of the present invention illustrate that the removable bracket 20 is attached to the motor housing via screws, one of ordinary skill in the art would readily understand that other fasteners such as hinges and bolts could also be employed to attach the removable bracket 20 to the housing 12.

Also illustrated in FIG. 1, in accordance with a preferred embodiment of the invention, a bushing 25 is located within the motor assembly. In accordance with a preferred embodiment of the invention the bushing 25 can be manually attached to the motor shaft 14 axially (after removal of the bracket 20) near the end of the motor assembly 10 so that, when repair is required, the bushing can be easily reached by removal of bracket 20.

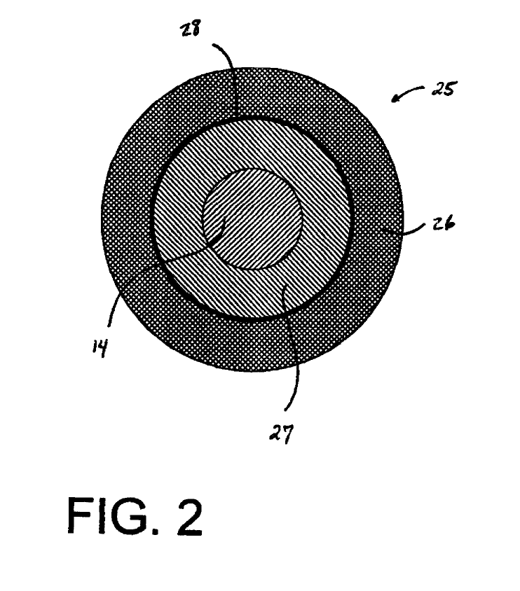

As illustrated in FIG. 2, in accordance with an exemplary embodiment of the present invention, the bushing 25 comprises a stationary outer case 26 that is secured in electrical contact with the housing 12, and an inner liner 27 that is in electrical contact with the motor shaft 14. The bushing 25 also includes an interface 28 located between the outer case 26 and the inner liner 27. In accordance with an exemplary embodiment of the present invention both the inner liner 27 and the outer case 26 are made up of conductive material. The interface can include an electrically conductive lubricant, so that the bearing 25 does not cause the motor shaft undue friction when rotating. Additionally, the bushing 25 can be manufactured in a wide variety of sizes that fit different sized motor shafts.

Due to the fact that the entirety of the bushing 25 is conductive and that bushing 25 is in electrical contact with both the housing 12 and the shaft 14, unwanted induced currents can be efficiently discharged to the ground potential of the motor housing through the bushing 25. The induced currents are discharged to electrical ground potential through bushing 25 as long as the resistance of the busing is less than the resistance of the conventional bearing assembly. As a result, the motor housing and the motor shaft are brought to the same electrical potential.

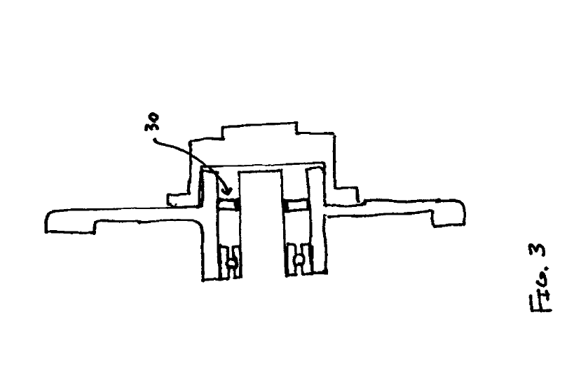

In accordance with another exemplary embodiment of the present invention, as illustrated in the cut out side view of FIG. 3, an outer bearing seal 30 can also be employed to quickly dissipate induced current in the shaft 14. As illustrated in FIG. 3 a seal 30 can be placed at an interface located between the motor shaft 14 and the outer housing 16. As described above, with respect to the bearing of FIG. 1, the bracket 20 can be removed and the seal can be axially placed on the shaft 14.

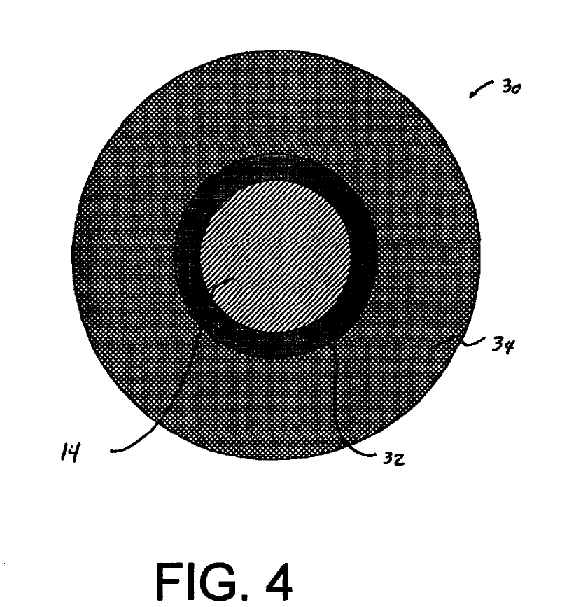

FIG. 4 is an axial view of the exemplary outer bearing seal 30. The outer bearing seal 30 comprises an inner liner 32 and an outer shell 34. The outer shell 34 of the seal 30 is made of a conductive material and is placed (when installed) in electrical contact with the housing 12. In one exemplary embodiment of the invention, the inner liner 32 can comprise a form fitting conductive material that creates a seal (an electrical contact) against the shaft 14 of the motor assembly 10. In another exemplary embodiment of the invention, the inner liner 32 can comprise a rubber like material or stuffing material that includes conductive strands connected between the lower end of the inner liner and the outer shell 34. Through the use of the outer bearing seal 30 any current induced in the motor assembly 10 is efficiently discharged through the outer bearing seal 30.

Additionally, one advantage of the bushing 25 and outer bearing seal 30 assemblies employed in exemplary embodiments of the present invention is that, in combination with the removable bracket 20, the bushing 25 and the outer bearing seal 30 can be easily installed or replaced. One merely needs to remove the bracket 20 and axially load either the seal 30 or bushing 25. As long as the seal 30 or bushing 25 is in constant contact with both the shaft 14 and the housing 12 of the motor assembly 10, current will be efficiently removed from the shaft 14.

While the foregoing description includes many details and specificities, it is to be understood that these have been included for purposes of explanation only, and are not to be interpreted as limitations of the present invention. For example, while the foregoing embodiments of the invention describe the current diversion mechanisms (e.g., a bushing and a seal) as being employed in a retrofit situations, one of ordinary skill in the art would envision that these current diversions could also be employed during the original manufacture of motor assemblies. Many modifications to the embodiments described above can be made without departing from the spirit and scope of the invention, as is intended to be encompassed by the following claims and their legal equivalents.

What is claimed is:

1. An apparatus used in combination with a motor for discharging current, wherein the motor includes a housing at an electrical ground potential and a rotatable motor shaft comprising induced currents, the apparatus comprising:
a bushing in electrical contact with both and an the housing and the shaft, the bushing further comprising;
a first part made of conductive material in electrical contact with the shaft;
a second part made of conductive material in electrical contact with the housing; and
a conductive material at an interface between the first part and the second part; and
a bracket connected to the housing.

2. The apparatus of claim 1, wherein the conductive material is electrically conductive grease.

3. The apparatus of claim 1, wherein the induced currents of the rotatable motor shaft are discharged to the housing at the electrical ground potential through the bushing.

4. The apparatus of claim 1, wherein the bracket is removable.

5. The apparatus of claim 1, wherein the bushing is removable.

6. The apparatus of claim 1, wherein the bushing is placed onto the rotatable motor shaft of the motor.

7. The apparatus of claim 1, wherein the bushing is employed retrofitted on an existing motor.

8. A method for installing a current discharge device on a motor, wherein the motor includes a housing at an electrical ground potential and a rotatable motor shaft comprising induced currents, the method comprising the steps of:
removing a bracket located on the motor;
placing a completely electrically conductive bushing into the motor so that a first part of the bushing is in electrical contact with the motor shaft and a second part of the bushing is in electrical contact with a motor housing; and
rotating the rotatable motor shaft to remove any induced currents from the motor shaft.

9. An apparatus used in combination with a motor for discharging current, wherein the motor includes a housing at an electrical ground potential and a rotatable motor shaft comprising induced currents, the retrofit apparatus comprising:
a seal in electrical contact with both and an the housing and the shaft, the seal further comprising;
a first part made of conductive material in direct contact with the shaft; and
a second part made of conductive material in direct contact with the housing;
wherein said first part creates a seal completely around the circumference of the shaft; and a bracket connected to the housing.

10. The apparatus of claim 9, wherein the induced currents of the rotatable motor shaft are discharged to the housing at the electrical ground potential through the seal.

11. The apparatus of claim 9, wherein the bracket is removable.

12. The apparatus of claim 9, wherein the seal is removable.

13. The apparatus of claim 9, wherein the bushing is placed onto the rotatable motor shaft of the motor.

14. The apparatus of claim 9, wherein the bushing is employed retrofitted on an existing motor.

15. A method for installing a current discharge device on a motor, the motor includes a housing at an electrical ground potential and a rotatable motor shaft comprising induced currents, the method comprising the steps of:
removing a bracket located on the motor;
placing a completely electrically conductive bushing into the motor so that a first part of the bushing is in electrical contact with the motor shaft and a second part of the bushing is in electrical contact with a motor housing; and
rotating the rotatable motor shaft to remove any induced currents from the motor shaft.
